(19) United States
(12) Patent Application Publication
(10) Pub. No.: US 2021/0399801 A1
(43) Pub. Date: Dec. 23, 2021

(54) METHOD FOR ANAYLZING OMCI PACKETS

(71) Applicant: Core Keepers Investment Inc.

(72) Inventor: Chung-Kai Tung, Taipei City (TW)

(21) Appl. No.: 17/349,973

(22) Filed: Jun. 17, 2021

Related U.S. Application Data
(60) Provisional application No. 63/041,829, filed on Jun. 20, 2020.

(51) Int. Cl. H04B 10/079; H04Q 11/00

(52) U.S. Cl. CPC H04B 10/0793; H04B 10/0799; H04Q 2011/0079; H04Q 11/0066; H04Q 11/0067

(57) ABSTRACT

The present invention provides a method for analyzing OMCI (ONT Management Control Interface) packets, comprising: transmitting, by an OLT (Optical Line Transmission), an OMCI packet including multiple settings; receiving, by an ONT (Optical Network Terminal), the OMCI packet; wherein the ONT includes an OMCI protocol analyzer, the OMCI protocol analyzer parse the settings and generates an ER-diagram (Entity Relationship Diagram).

### CROSS REFERENCE TO RELATED APPLICATION

The present application claims priority to U.S. Provisional Application Ser. No. 63/041,829, filed on Jun. 20, 2020, which are hereby incorporated by reference in their entirety.

### FIELD

The present invention relates to a method for analyzing OMCI (ONT Management Control Interface) packets and, more particular, the method is by utilizing an OMCI protocol analyzer that generates a text based ER-diagram (Entity Relationship Diagram).

### BACKGROUND

ITU-T Recommendation (ITU Telecommunication Standardization Sector) G.988 defines a management and control interface for ONU (Optical Network Unit). ITU-T G.988 comprises one recommendation: G.988, ONU management and control interface (OMCI) specification, 2010. Further, the ER-diagram (Entity Relationship Diagram) is defined in section 8.2—“Managed Entity Relation Diagram.”

A GPON (Gigabit Passive Optical Network) analyzer is an equipment plugged between an ONU and an OLT (Optical Line Transmission) and intercepts all activities, for analyzing data collected by GPON analyzer. As such, the analysis results may be displayed in different forms, including graphs, lists, tables, charts.

While the GPON analyzer is powerful, such equipment may not be ubiquitous since it is very expansive, and that is, it usually costs more than 200,000 USD. Further, the feasibility is sometimes limited, because plugging a GPON analyzer between an ONU and an OLT may not be allowed in some testing or field environments.

### SUMMARY OF THE DISCLOSURE

This invention relates to a method for analyzing OMCI (ONT Management Control Interface) packets and, more particular, the method is by utilizing an OMCI protocol analyzer that generates a text based ER-diagram (Entity Relationship Diagram).

According to the present invention, a method for analyzing OMCI (ONT Management Control Interface) packets is disclosed. The method comprises the following steps: transmitting, by an OLT (Optical Line Transmission), an OMCI packet including multiple settings; receiving, by an ONT (Optical Network Terminal), the OMCI packet; wherein the ONT includes an OMCI protocol analyzer, the OMCI protocol analyzer parse the settings and generates an ER-diagram (Entity Relationship Diagram).

Preferably, the ER-diagram is a text based ER-diagram.

Preferably, the text based ER-diagram includes a first bridge and a second bridge.

Preferably, the text based ER-diagram includes a plurality of characters for notation.

Preferably, the plurality of characters includes the following descriptions:
A>B: A has a pointer to B;
A<B: B has a pointer to A;
A< >B: A has a pointer to B and B has a pointer to A; and
A-B: A and B has no pointer to each other, but they are implicitly related because they have same me id;
wherein A and B are each an object.

Preferably, each object in the ER-diagram includes a class-id, a me-id.

### BRIEF DESCRIPTION OF THE DRAWINGS

FIG. 1 is a drawing illustrating a typical provision from OLT to ONT;

FIG. 2 is a drawing illustrating the comparison the ER-diagram as generated by the ONT analyzes built on the OMCI protocol analyzer and a high level object relation;

FIG. 3 illustrates the first bridge of FIG. 2 and the corresponding high level object relation; and

FIG. 4 illustrates the second bridge of FIG. 2 and the corresponding high level object relation.

### DETAILED DESCRIPTION

Unless defined otherwise, all technical and scientific terms used herein have the same meanings as commonly understood by one of skill in the art to which this disclosure belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

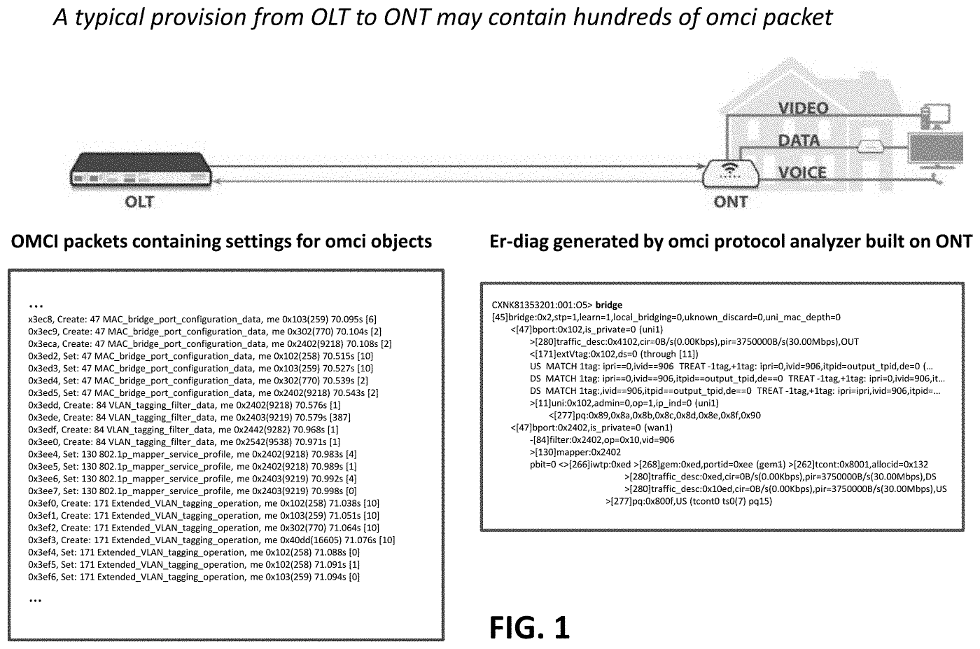

Reference is made to FIG. 1, which is a drawing illustrating a typical provision from OLT to ONT. During the transmission, it may contain hundreds of OMCI packet. As shown in FIG. 1, and OLT (Optical Line Termination) communicates with ONT (Optical Network Terminal). Also shown in FIG. 1, the ONT further transmits video, data or voice signal with other devices (or other hardware, such a laptop, desk computer, TV and etc.). Further, an OMCI protocol analyser is built in the ONT. The OMCI protocol analyser generates an ER-diagram (Entity Relationship Diagram).

OMCI packets are packets send from OLT to ONT, containing settings for OMCI objects. A portion of the settings is listed in the following:

. . .
x3ec8, Create: 47 MAC_bridge_port_configuration_data, me 0x103(259) 70.095s [6]
0x3ec9, Create: 47 MAC_bridge_port_configuration_data, me 0x302(770) 70.104s [2]
0x3eca, Create: 47 MAC_bridge_port_configuration_data, me 0x2402(9218) 70.108s [2]
0x3ed2, Set: 47 MAC_bridge_port_configuration_data, me 0x102(258) 70.515s [10]
0x3ed3, Set: 47 MAC_bridge_port_configuration_data, me 0x103(259) 70.527s [10]
0x3ed4, Set: 47 MAC_bridge_portconfiguration_data, me 0x302(770) 70.539s [2]
0x3ed5, Set: 47 MAC_bridge_portconfiguration_data, me 0x2402(9218) 70.543s [2]
0x3edd, Create: 84 VLAN_tagging_filter_data, me 0x2402(9218) 70.576s [1]
0x3ede, Create: 84 VLAN_tagging_filter_data, me 0x2403(9219) 70.579s [387]
0x3edf, Create: 84 VLAN_tagging_filter_data, me 0x2442(9282) 70.968s [1]
0x3ee0, Create: 84 VLAN_tagging_filter_data, me 0x2542(9538) 70.971s [1]
0x3ee4, Set: 130 802.1p_mapper_service_profile, me 0x2402(9218) 70.983s [4]
0x3ee5, Set: 130 802.1p_mapper_service_profile, me 0x2402(9218) 70.989s [1]
0x3ee6, Set: 130 802.1p_mapper_service_profile, me 0x2403(9219) 70.992s [4]
0x3ee7, Set: 130 802.1p_mapper_service_profile, me 0x2403(9219) 70.998s [0]
0x3ef0, Create: 171 Extended_VLAN_tagging_operation, me 0x102(258) 71.038s [10]
0x3ef1, Create: 171 Extended_VLAN_tagging_operation, me 0x103(259) 71.051s [10]
0x3ef2, Create: 171 Extended_VLAN_tagging_operation, me 0x302(770) 71.064s [10]
0x3ef3, Create: 171 Extended_VLAN_tagging_operation, me 0x40dd(16605) 71.076s [10]
0x3ef4, Set: 171 Extended_VLAN_tagging_operation, me 0x102(258) 71.088s [0]
0x3ef5, Set: 171 Extended_VLAN_tagging_operation, me 0x102(258) 71.091s [1]
0x3ef6, Set: 171 Extended_VLAN_tagging_operation, me 0x103(259) 71.094s [0]
. . .

It can also be understood that, from FIG. 1, the OMCI protocol analyzer built on the ONT parse the settings of OMCI packets, and generates a text based ER-diagram. Therefore, when such OMCI packet is received at the ONT, the OMCI protocol analyzer built on the ONT analyzes the provision from OLT, generates a high level ER-diagram on the fly, and presents the result in an easily-understood format on CPE console (Customer Premise Equipment). The format is presented in the following:

```
CXNK81353201:001:O5> bridge
[45]bridge:0x2,stp=1,learn=1,local_bridging=0,uknown_discard=0,uni_mac_depth=0
  <[47]bport:0x102,is_private=0 (uni1)
    >[280]traffic_desc:0x4102,cir=0B/s(0.00Kbps),pir=3750000B/s(30.00Mbps),OUT
      <[171]extVtag:0x102,ds=0 (through [11])
      US MATCH 1tag: ipri==0,ivid==906 TREAT −1tag,+1tag: ipri=0,ivid=906,itpid=output_tpid,de=0 (...
      DS MATCH 1tag: ipri==0,ivid==906,itpid==output_tpid,de==0 TREAT −1tag,+1tag: ipri=0,ivid=906,it...
      DS MATCH 1tag:,ivid==906,itpid==output_tpid,de==0 TREAT −1tag,+1tag: ipri=ipri,ivid=906,itpid=...
      >[11]uni:0x102,admin=0,op=1,ip_ind=0 (uni1)
        <[277]pq:0x89,0x8a,0x8b,0x8c,0x8d,0x8e,0x8f,0x90
  <[47]bport:0x2402,is_private=0 (wan1)
      −[84]filter:0x2402,op=0x10,vid=906
      >[130]mapper:0x2402
      pbit=0 <>[266]iwtp:0xed >[268]gem:0xed,portid=0xee (gem1) >[262]tcont:0x8001,allocid=0x132
      >[280]traffic_desc:0xed,cir=0B/s(0.00Kbps),pir=3750000B/s(30.00Mbps),DS
      >[280]traffic_desc:0x10ed,cir=0B/s(0.00Kbps),pir=3750000B/s(30.00Mbps),US
          >[277]pq:0x800f,US (tcont0 ts0(7) pq15)
```

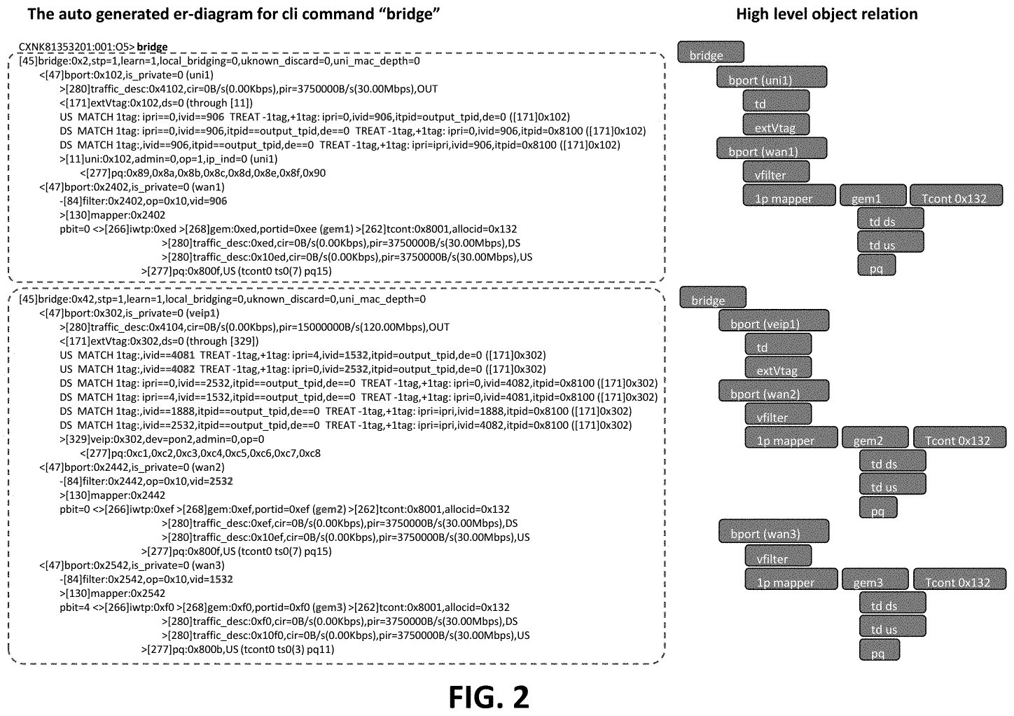

Reference is collectively made to FIG. 2, which compares the ER-diagram as generated by the ONT analyzes built on the OMCI protocol analyzer and a high level object relation. It can be seen in FIG. 2, the text based ER-diagrams are listed to the left (or auto generated ER-diagram for cli command “bridge”), also listed in the following:

### The First Bridge

```
CXNK81353201:001:O5> bridge
[45]bridge:0x2,stp=1,learn=1,local_bridging=0,uknown_discard=0,uni_mac_depth=0
  <[47]bport:0x102,is_private=0 (uni1)
    >[280]traffic_desc:0x4102,cir=0B/s(0.00Kbps),pir=3750000B/s(30.00Mbps),OUT
      <[171]extVtag:0x102,ds=0 (through [11])
      US MATCH 1tag: ipri==0,ivid==906 TREAT −1tag,+1tag: ipri=0,ivid=906,itpid=output_tpid,de=0 (...
      DS MATCH 1tag: ipri==0,ivid==906,itpid==output_tpid,de==0 TREAT −1tag,+1tag: ipri=0,ivid=906,it...
      DS MATCH 1tag:,ivid==906,itpid==output_tpid,de==0 TREAT −1tag,+1tag: ipri=ipri,ivid=906,itpid=...
      >[11]uni:0x102,admin=0,op=1,ip_ind=0 (uni1)
        <[277]pq:0x89,0x8a,0x8b,0x8c,0x8d,0x8e,0x8f,0x90
  <[47]bport:0x2402,is_private=0 (wan1)
      −[84]filter:0x2402,op=0x10,vid=906
      >[130]mapper:0x2402
      pbit=0 <>[266]iwtp:0xed >[268]gem:0xed,portid=0xee (gem1) >[262]tcont:0x8001,allocid=0x132
      >[280]traffic_desc:0xed,cir=0B/s(0.00Kbps),pir=3750000B/s(30.00Mbps),DS
      >[280]traffic_desc:0x10ed,cir=0B/s(0.00Kbps),pir=3750000B/s(30.00Mbps),US
          >[277]pq:0x800f,US (tcont0 ts0(7) pq15)
```

### The Second Bridge

```
[45]bridge:0x42,stp=1,learn=1,local_bridging=0,uknown_discard=0,uni_mac_depth=0
  <[47]bport:0x302,is_private=0 (veip1)
    >[280]traffic_desc:0x4104,cir=0B/s(0.00Kbps),pir=15000000B/s(120.00Mbps),OUT
    <[171]extVtag:0x302,ds=0 (through [329])
    US MATCH 1tag:,ivid==4081 TREAT −1tag,+1tag: ipri=4,ivid=1532,itpid=output_tpid,de=0 ([171]0x302)
    US MATCH 1tag:,ivid==4082 TREAT −1tag,+1tag: ipri=0,ivid=2532,itpid=output_tpid,de=0 ([171]0x302)
    DS MATCH 1tag: ipri==0,ivid==2532,itpid==output_tpid,de==0 TREAT −1tag,+1tag: ipri=0,ivid=4082,itpid=0x8100
    DS MATCH 1tag: ipri==4,ivid==1532,itpid==output_tpid,de==0 TREAT −1tag,+1tag: ipri=0,ivid=4081,itpid=0x8100
    DS MATCH 1tag:,ivid==1888,itpid==output_tpid,de==0 TREAT −1tag,+1tag: ipri=ipri,ivid=1888,itpid=0x8100
    DS MATCH 1tag:,ivid==2532,itpid==output_tpid,de==0 TREAT −1tag,+1tag: ipri=ipri,ivid=4082,itpid=0x8100
    >[329]veip:0x302,dev=pon2,admin=0,op=0
      <[277]pq:0xc1,0xc2,0xc3,0xc4,0xc5,0xc6,0xc7,0xc8
  <[47]bport:0x2442,is_private=0 (wan2)
    −[84]filter:0x2442,op=0x10,vid=2532
    >[130]mapper:0x2442
    pbit=0 <>[266]iwtp:0xef >[268]gem:0xef,portid=0xef (gem2) >[262]tcont:0x8001,allocid=0x132
    >[280]traffic_desc:0xef,cir=0B/s(0.00Kbps),pir=3750000B/s(30.00Mbps),DS
    >[280]traffic_desc:0x10ef,cir=0B/s(0.00Kbps),pir=3750000B/s(30.00Mbps),US
        >[277]pq:0x800f,US (tcont0 ts0(7) pq15)
  <[47]bport:0x2542,is_private=0 (wan3)
    −[84]filter:0x2542,op=0x10,vid=1532
    >[130]mapper:0x2542
    pbit=4 <>[266]iwtp:0xf0 >[268]gem:0xf0,portid=0xf0 (gem3) >[262]tcont:0x8001,allocid=0x132
    >[280]traffic_desc:0xf0,cir=0B/s(0.00Kbps),pir=3750000B/s(30.00Mbps),DS
    >[280]traffic_desc:0x10f0,cir=0B/s(0.00Kbps),pir=3750000B/s(30.00Mbps),US
        >[277]pq:0x800b,US (tcont0 ts0(3) pq11)
```

Further, the high level object relations are listed to the right as a comparison to the text based ER-diagram. The CLI output could be easily mapped to a high level object relation, and this gives a quick overview of what is configured from OLT.

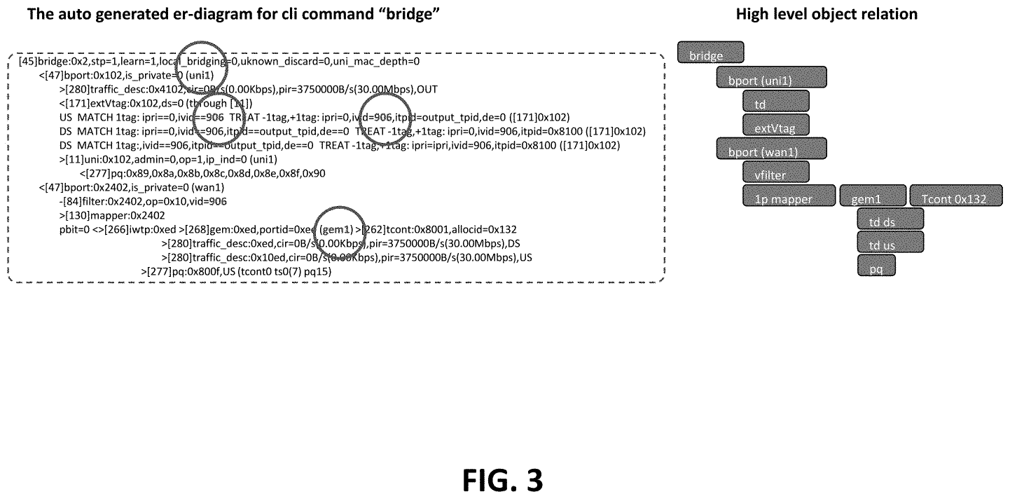

Reference is next made to FIG. 3, which illustrates the first bridge of FIG. 2 and the corresponding high level object relation. According to FIG. 3, it can be interpreted that it has 1 UNI with 1 VLAN translation: 906->906. Further, VID 906 goes to uplink GEM1. In sum, according to FIG. 3, it means that the OLT sets up a bridge path of VID 906 pass-through.

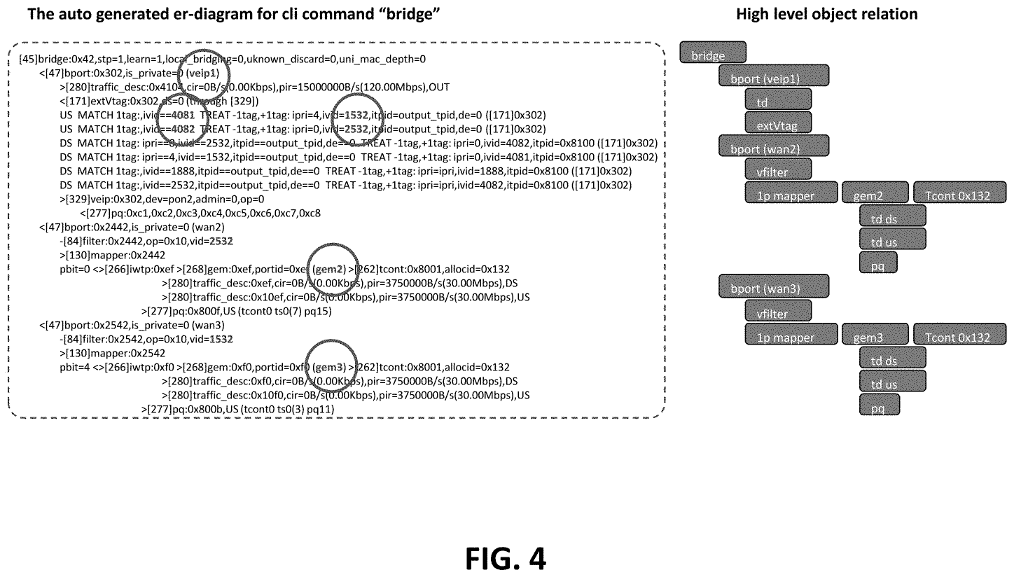

Reference is next made to FIG. 4, which illustrates the second bridge of FIG. 2 and the corresponding high level object relation. For the second bridge as shown in FIG. 4 (or FIG. 2), it has 1 VEIP with 2 VLAN translation: 4081->1532 & 4082->2532. Further, VID 1532 goes to uplink GEM2, VID 2532 goes to uplink GEM3. In sum, according to FIG. 4, it means that the OLT sets up a route with 2 router WAN interface, where one interface has VID 4081 and the other has VID 4082, and VID are translated to VID 1532 & 2532 respectively to OLT.

Reference is collective made to FIGS. 1 to 4, the ER-diagram, according to the present invention, special characters are used for the notation of the following 4 object relations:

A>B: A has pointer to B
A<B: B has pointer to A
A< >B: A has pointer to B and B has pointer to A
A-B: A & B has no pointer to each other, but they are implicitly related because they have same me id

In sum, the operation of the present invention can be understood as the OMCI protocol analyser parses the OMCI (ONT Management Control Interface) packets provisioned from OLT (Optical Line Termination), analyses the relations between OMCI objects and generates the ER-diagram on the fly. Further, the ER-diagram result could be retrieved by CLI (Command-Line Interface) command.

In sum, one of the purposes of the present invention is to provide an easily readable ER-diagram comparable to a high level overview, so that what OLT wants from ONU device can be easily understood. Further, the present invention can be applied to different environments, such as GPON (Gigabit Passive Optical Networks), XGPON (10G-PON) ONU that runs OMCI protocol.

Further, unlike traditional GPON or XGPON protocol analyser, which is expansive and may not always be available, the ER-diagram generator is build-in on ONU, so that the user can use it for issue debugging or OLT provisioning understanding anywhere and anytime.

In sum, the present invention overcomes certain shortcomings to the conventional technologies, such as: (a) no special hardware equipment is required; (b) tt can be implemented on all ONUs with almost no cost; (c) the result can be displayed on a text terminal, which could be the only available debug tool in most field environment; and (d) the user can get the high level view of the OMCI configuration on the fly, and no special setup is required.

It is worth to note that all the ONU devices that runs the OMCI protocol may apply the present invention.

In sum, according to the present invention, no special hardware equipment is further required. Moreover, the present invention can be implemented on all ONUs with almost no cost. Further, results can be displayed on a text terminal, which could be the only available debug tool in most field environment. Last but not the least, the user can get the high level view of the OMCI configuration on the fly, no special setup is required.

In sum, the present invention can be applied to all ONU devices that runs the OMCI protocol, which expands the applications for the present invention.

In sum, ONU software parses the OMCI packets provisioned from OLT (Optical Line Transmission), analyzes the relations between OMCI objects and generates an ER-diagram (Entity Relationship Diagram) on the fly. Further, the ER-diagram result could be retrieved by CLI (Command-Line Interfaces). Further, in the ER-diagram, each object would have its class-id, me-id and some important attributes displayed.

1. A method for analyzing OMCI (ONT Management Control Interface) packets, comprising:
transmitting, by an our (Optical Line Transmission), an OMCI packet including multiple settings;
receiving, by an ONT (Optical Network Terminal), the OMCI packet;
wherein the ONT includes an OMCI protocol analyzer, the OMCI protocol analyzer parse the settings and generates an ER-diagram (Entity Relationship Diagram).

2. The method for analyzing OMCI packets according to claim 1, wherein the ER-diagram is a text based ER-diagram.

3. The method for analyzing OMCI packets according to claim 2, wherein the text based ER-diagram includes a first bridge and a second bridge.

4. The method for analyzing OMCI packets according to claim 2, wherein the text based ER-diagram includes a plurality of characters for notation.

5. The method for analyzing OMCI packets according to claim 4, wherein the plurality of characters includes the following descriptions:
A>B: A has a pointer to B;
A<B: B has a pointer to A;
A< >B: A has a pointer to B and B has a pointer to A; and
A-B: A and B has no pointer to each other, but they are implicitly related because they have same me id;
wherein A and B are each an object.

6. The method for analyzing OMCI packets according to claim 5, each object in the ER-diagram includes a class-id, a me-id.
